(19) United States
(12) Patent Application Publication
(10) Pub. No.: US 2022/0179138 A1
(43) Pub. Date: Jun. 9, 2022

(54) WAVELENGTH CONVERSION MEMBER AND UTILIZATION THEREOF, BACKLIGHT UNIT AND IMAGE DISPLAY DEVICE

(71) Applicant: SHOWA DENKO MATERIALS CO., LTD., Chiyoda-ku, Tokyo (JP)

(72) Inventors: Mayumi SATOH, Chiyoda-ku, Tokyo (JP); Tomoyuki NAKAMURA, Chiyoda-ku, Tokyo (JP); Futoshi OIKAWA, Chiyoda-ku, Tokyo (JP); Katsuyoshi SAKAMOTO, Chiyoda-ku, Tokyo (JP); Yuma YOSHIDA, Chiyoda-ku, Tokyo (JP); Yoshitaka KATSUTA, Chiyoda-ku, Tokyo (JP)

(21) Appl. No.: 17/437,034

(22) PCT Filed: Jun. 14, 2019
(86) PCT No.: PCT/JP2019/023636

§ 371 Date: Sep. 7, 2021

(51) Int. Cl. G02B 5/20; G02F 1/1335; C08J 5/18; C09K 11/56; C09K 11/88

(52) U.S. Cl. CPC G02B 5/206; G02F 1/133514; G02F 1/133615; C09K 11/565; C09K 11/883; C08J 5/18

(57) ABSTRACT

A wavelength conversion member includes a wavelength conversion layer that contains a phosphor, the wavelength conversion member having a face that has an arithmetic average roughness Ra of 5 μm or more and a maximum height Rz of from 30 to 250 μm.

### TECHNICAL FIELD

The present disclosure relates to a wavelength conversion member and utilization thereof, and to a a backlight unit and an image display device.

### BACKGROUND ART

Image display devices such as liquid crystal display devices are provided with a backlight unit. The backlight unit includes a wavelength conversion member containing phosphors that emit light using light from a light source.

In the field of image display devices, improvements in color reproducibility have been desired for the displays. As a means for improving the color reproducibility, wavelength conversion members that contain quantum dot phosphors, such as those disclosed in Japanese National Phase Publication (JP-A) No. 2013-544018 and International Publication (WO) No. 2016/052625, have attracted attentions.

### SUMMARY OF INVENTION

### Technical Problem

In general, wavelength conversion members of backlight units are used by being inserted between various members such as diffuser panels, light guide plates, reflection films and brightness enhancement films. For example, in backlight units mounted in televisions, there are cases in which a diffuser panel for diffusing light from a point light source from the rear side to convert the point light source to an area light source is provided, and a wavelength conversion member is disposed so as to oppose the diffuser panel. Further, in backlight units mounted in monitors of personal computers or the like, there are cases in which a light guide plate is used to guide light originating from light sources provided at a side face, and a wavelength conversion member is disposed so as to oppose the light guide plate.

Wavelength conversion members are disposed between other members in a movable manner rather than being incorporated such that they are tightly adhered to other adjacent members. Accordingly, when an image display device is subjected to vibration or a shock, the wavelength conversion member may be struck by other members, resulting in scratches on the surface of the wavelength conversion member. Further, when a wavelength conversion layer is disposed so as to oppose a light guide plate, the wavelength conversion layer is particularly prone to scratches on the surface since light guide plates generally have an uneven surface.

In view of the foregoing situation, the present disclosure is directed to providing a wavelength conversion member having excellent impact resistance and a utilization thereof, and a backlight unit and an image display device using the same.

### Solution to Problem

Means for solving the above problems include the following.

(1) A wavelength conversion member, comprising a wavelength conversion layer that comprises a phosphor, the wavelength conversion member having a face that has an arithmetic average roughness Ra of 5 μm or more and a maximum height Rz of from 30 to 250 μm.
(2) The wavelength conversion member according to (1), comprising a covering material disposed at one side, or covering materials disposed at respective sides, of the wavelength conversion layer, wherein:

a face of the covering material disposed at one side of the wavelength conversion layer, the face being at a side that is not adjacent to the wavelength conversion layer, has an arithmetic average roughness Ra of 5 μm or more and a maximum height Rz of from 30 to 250 μm; or

at least one of the faces of the covering materials disposed at respective sides of the wavelength conversion member, the at least one of the faces being at a side that is not adjacent to the wavelength conversion layer, has an arithmetic average roughness Ra of 5 μm or more and a maximum height Rz of from 30 to 250 μm.

(3) The wavelength conversion member according to (2), wherein the wavelength conversion member has a barrier property against at least one of oxygen or water.
(4) The wavelength conversion member according to any one of (1) to (3), wherein the phosphor comprises a quantum dot phosphor.
(5) The wavelength conversion member according to (4), wherein the quantum dot phosphor comprises a compound that contains at least one of Cd or In.
(6) The wavelength conversion member according to any one of (1) to (5), wherein the wavelength conversion layer comprises a cured product of a resin composition that comprises:

a phosphor;

a thiol compound;

at least one selected from the group consisting of a (meth)acrylic compound and a (meth)allyl compound; and

a photopolymerization initiator.

(7) A backlight unit, comprising the wavelength conversion member according to any one of (1) to (6) and a light source.
(8) The backlight unit according to (7), further comprising a light guide plate disposed so as to oppose the wavelength conversion member.
(9) The backlight unit according to (8), wherein a face of the light guide plate that opposes the wavelength conversion member has an arithmetic average roughness Ra of 30 μm or more.
(10) An image display device, comprising the backlight unit according to any one of (7) to (9).
(11) Utilizing the wavelength conversion member according to any one of (1) to (8), in an arrangement opposing a light guide plate having a face that has an arithmetic average roughness Ra of 30 μm or more, comprising arranging the wavelength conversion member such that the face of the wavelength conversion member having an arithmetic average roughness Ra of 5 μm or more and a maximum height Rz of from 30 to 250 μm opposes the face of the light guide plate having an arithmetic average roughness Ra of 30 μm or more.

### Advantageous Effects of Invention

According to the present disclosure, a wavelength conversion member having excellent impact resistance and a utilization thereof, and a backlight unit and an image display device using the same are provided.

### BRIEF DESCRIPTION OF DRAWINGS

FIG. 1 is a schematic cross-sectional view showing an example of the schematic configuration of a wavelength conversion member.

FIG. 2 is a diagram showing an example of the schematic configuration of a backlight unit.

FIG. 3 is a diagram showing an example of the schematic configuration of an image display device.

### DESCRIPTION OF EMBODIMENTS

Embodiments for carrying out the invention will be described below in detail. However, the invention is not limited to the following embodiments. In the following embodiments, components (including elemental steps, etc.) thereof are not essential unless otherwise specified. The same applies to numerical values and ranges, which do not limit the invention.

In the present disclosure, a numerical range specified using “(from) . . . to . . . ” represents a range including the numerical values noted before and after “to” as a minimum value and a maximum value, respectively.

In the numerical ranges described in a stepwise manner in the present disclosure, the upper limit value or the lower limit value described in one numerical range may be replaced with the upper limit value or the lower limit value of another numerical range described in a stepwise manner. Further, in the numerical ranges described in the present disclosure, the upper limit value or the lower limit value of the numerical ranges may be replaced with the values shown in the Examples.

In the present disclosure, each component may include plural substances corresponding to the component. In a case in which plural substances corresponding to respective components are present in a composition, an amount or content of each component in the composition means the total amount or content of the plural substances present in the composition unless otherwise specified.

In the present disclosure, each component may include plural kinds of particles corresponding to the component. In the case in which plural kinds of particles corresponding to respective components are present in a composition, a particle size of the component means a value with respect to the mixture of the plural kinds of particles present in the composition, unless otherwise specified.

The term “layer” or “film” as used herein encompasses, when a region in which the layer or the film is present is observed, not only a case in which the layer is formed over the entire observed region, but also a case in which the layer is formed at only a part of the observed region.

The term “layered” as used herein means disposing layers on one another, in which two or more layers may be bonded with each other, or may be attachable to/detachable from one another.

In the present disclosure, the term “(meth)acryloyl group” means at least one of acryloyl group or methacryloyl group, the term “(meth)acrylic” means at least one of acrylic or methacrylic, the term “(meth)acrylate” means at least one of acrylate or methacrylate, and the term “(meth)allyl” means at least one of allyl and methallyl.

In a case in which an embodiment is described herein with reference to a drawing, the configuration of the embodiment is not limited by the configuration illustrated in the drawing. The sizes of members in respective drawings are conceptual, and the relative relationships between the sizes of the members are not limited thereto. In the respective drawings, members having substantially the same function may be denoted with the same reference signs, and redundant explanations may be omitted.

Wavelength Conversion Member

The wavelength conversion member according the present disclosure includes a wavelength conversion layer that contains a phosphor, the wavelength conversion member having a face that has an arithmetic average roughness Ra of 5 μm or more and a maximum height Rz of from 30 to 250 μm.

Hereinafter, the “arithmetic average roughness Ra of 5 μm or more and a maximum height Rz of from 30 to 250 μm” will also be referred as a “specific surface roughness”.

The wavelength conversion member according to the present disclosure may consist of the wavelength conversion layer, or may include another component, such as a covering material, which will be described later, as necessary.

The term “face” of the wavelength conversion member refers to a main face of the wavelength conversion member.

The wavelength conversion layer in the present disclosure may be a cured product of a resin composition described later.

The wavelength conversion member according to the present disclosure has excellent impact resistance. Although the reason for this is unclear, it is presumed that the specific surface roughness can reduce the contact area of the wavelength conversion member with other members in a backlight unit, whereby generation of scratches on the surface of the wavelength conversion member can be suppressed.

The shape of the wavelength conversion member is not particularly limited, and examples thereof include a film shape and a lens shape. When the wavelength conversion member is applied to a backlight unit described later, the wavelength conversion member is preferably in the form of a film.

The location of the face that has the specific surface roughness in the wavelength conversion member is not particularly limited. When the wavelength conversion member is in the form of a film, for example, at least one of the faces of the wavelength conversion member in the form of a film has the specific surface roughness, and respective faces may have the specific surface roughness.

When the wavelength conversion member is in the form of a film, for example, the face that has the specific surface roughness may be a face of the wavelength conversion layer or may be a face of a covering material if the wavelength conversion member includes a covering material described later.

In a case in which the wavelength conversion member is disposed so as to oppose a light guide plate in a backlight unit, it is preferable that at least the face of the wavelength conversion member that is adjacent to the light guide plate satisfies the specific surface roughness. Light guide plates generally have an uneven surface, and therefore, when a backlight unit is subjected to vibration or a shock, the wavelength conversion member is prone to scratches on the surface. When the face of the wavelength conversion member that is adjacent to the light guide plate satisfies the specific surface roughness, impact resistance of the said face is improved, whereby the generation of the scratches can be suppressed.

Further, when the wavelength conversion member is disposed so as to oppose an optical film, it is preferable that the wavelength conversion member and the optical film are not brought into optical contact. From the viewpoint of preventing the optical contact, the face of the wavelength conversion member that is adjacent to the optical film has surface roughness, and may satisfy the specific surface roughness.

The method for manufacturing a wavelength conversion member that has the specific surface roughness is not particularly limited. For example, such a wavelength conversion member can be manufactured by controlling the particle size and the amount of a filler, which may be contained in the wavelength conversion member or in a covering material, or the amount of a resin applied.

The material of the filler is not particularly limited, and the filler may be an inorganic filler or may be an organic filler. From the viewpoint of impact resistance, the filler is preferably an organic filler.

In the wavelength conversion member according to the present disclosure, the arithmetic average roughness Ra is 5 μm or more, and from the viewpoint of impact resistance, the arithmetic average roughness Ra is preferably 7 μm or more, and more preferably 9 μm or more. The upper limit of the arithmetic average roughness Ra is not particularly limited, and the arithmetic average roughness Ra may be 50 μm or less.

In the wavelength conversion member according to the present disclosure, the maximum height Rz is from 30 to 250 preferably from 40 to 200 more preferably from 50 to 190 and further preferably from 60 to 180 When the maximum height Rz is 30 μm or more, the impact resistance tends to be favorable. Further, when the maximum height Rz is 250 μm or less, its influence on the calculation of the arithmetic average roughness Ra, to the effect that the arithmetic average roughness Ra becomes a superficially large value owing to the large maximum height Rz, can be reduced.

In the wavelength conversion member according to the present disclosure, the arithmetic average height Sa is not particularly limited. From the viewpoint of impact resistance, the arithmetic average height Sa is preferably 5 μm or more, more preferably 7 μm or more, and further preferably 9 μm or more. The upper limit of the arithmetic average height Sa is not particularly limited, and the arithmetic average height Sa may be 50 μm or less.

In the wavelength conversion member according to the present disclosure, the maximum height Sz is not particularly limited. From the viewpoint of impact resistance, the maximum height Sz is preferably from 30 to 250 μm, more preferably from 40 to 200 μm, further preferably from 50 to 190 μm, and particularly preferably from 60 μm to 180 μm.

In the present disclosure, the arithmetic average roughness Ra refers to a value measured using a 3D microscope (for example, Olympus Corporation, model OLS4100, magnification: 10×). The analysis range is set to be a line roughness with a length of 1289 μm. As for the analysis method, analysis parameters are set to be roughness parameters with cutoff values of λC: none, λS: none, and λf: none.

Here, λC, λS, and λf indicate methods for obtaining the contour curve for calculating Ra. The contour curve includes a cross-section curve, a roughness curve, and a waviness curve. The cross-sectional curve is a curve obtained by applying a low-pass filter having a cutoff value of λS to the measured cross-sectional curve. The roughness curve is a contour curve obtained by cutting off high wavelength components from the cross-sectional curve with a high-pass filter having a cutoff value of λC. The waviness curve is a contour curve obtained by sequentially applying contour curve filters having cutoff values λf and λC to the cross-sectional curve. The λf contour curve filter cuts off long wavelength components and the λC contour curve filter cuts off short wavelength components.

In the present disclosure, the maximum height Rz refers to a value measured using a 3D microscope (for example, Olympus Corporation, model OLS4100, magnification: 10×). The analysis range is set to be a line roughness with a length of 1289 μm. As for the analysis method, analysis parameters are set to be roughness parameters with cutoff values of λC: none, λS: none, and λf: none. Rz can be calculated at the same time as Ra is calculated.

In the present disclosure, the arithmetic average height Sa refers to a value measured using a 3D microscope (for example, Olympus Corporation, model OLS4100, magnification: 10×). The analysis range is set to be an area roughness of 1282 μm×1279 μm. As for the analysis method, analysis parameters are set to be roughness parameters with cutoff values of C: none, λS: none, and λf: none.

In the present disclosure, the arithmetic average height Sz refers to a value measured using a 3D microscope (for example, Olympus Corporation, model OLS4100, magnification: 10×). The analysis range is set to be an area roughness of 1282 μm×1279 μm. As for the analysis method, analysis parameters are set to be roughness parameters with cutoff values of C: none, λS: none, and λf: none.

The average thickness of the wavelength conversion member is, for example, preferably from 50 to 500 μm, more preferably from 65 to 450 μm, and further preferably from 80 to 400 μm. When the average thickness of the wavelength conversion member is 50 μm or more, the wavelength conversion efficiency tends to be further improved, and when the average thickness is 500 μm or less, a thinner backlight unit tends to be obtained when the wavelength conversion member is applied to a backlight unit.

The average thickness of the wavelength conversion member is obtained as, for example, an arithmetic average value of the thicknesses of random three points measured using a micrometer.

From the viewpoint of further improving the light utilization efficiency, the total light transmittance of the wavelength conversion member is preferably 75% or less, more preferably 70% or less, and further preferably 65% or less. The total light transmittance of the wavelength conversion member can be measured according to the measurement method of JIS K 7136:2000.

From the viewpoint of further improving the light utilization efficiency, the haze of the wavelength conversion member is preferably 90% or more, more preferably 95% or more, and further preferably 98% or more. The haze of the wavelength conversion member can be measured according to the measurement method of JIS K 7136:2000.

In another embodiment of the present disclosure, the wavelength conversion member has a wavelength conversion layer containing a phosphor and has a face having an arithmetic average roughness Ra of 17 μm or more. The wavelength conversion member according to this embodiment has excellent impact resistance.

In the wavelength conversion member according to this embodiment, the arithmetic average roughness Ra is 17 μm or more, and from the viewpoint of impact resistance, the arithmetic average roughness Ra is preferably 19 μm or more, and more preferably 21 μm or more. The upper limit of the arithmetic average roughness Ra is not particularly limited, and the arithmetic average roughness Ra may be 50 μm or less.

In the wavelength conversion member according to this embodiment, the maximum height Rz is not particularly limited, and is preferably from 30 to 250 more preferably from 40 to 200 further preferably from 50 to 190 and particularly preferably from 60 to 180 When the maximum height Rz is 30 μm or more, the impact resistance tends to be favorable. Further, when the maximum height Rz is 250 μm or less, its influence on the calculation of the arithmetic average roughness Ra, to the effect that the arithmetic average roughness Ra becomes a superficially large value owing to the large maximum height Rz, can be reduced.

For details of the wavelength conversion member according to this embodiment other than the arithmetic average roughness Ra and the maximum height Rz, the details of the above-described wavelength conversion member having the specific surface roughness can be applied.

Covering Material

The wavelength conversion member may have a covering material disposed at one side, or covering materials disposed at respective sides, of the wavelength conversion layer. In this case, a face of the covering material disposed at one side of the wavelength conversion layer, the face being at a side that is not adjacent to the wavelength conversion layer, may have the specific surface roughness, or at least one of the faces of the covering materials disposed at respective sides of the wavelength conversion member, the at least one of the faces being at a side which is not adjacent to the wavelength conversion layer, may have the specific surface roughness.

The average thickness of the covering material is, for example, preferably from 10 to 200 more preferably from 12 to 170 and further preferably from 15 to 150 When the average thickness is 10 μm or more, functions such as barrier property tend to be sufficient, and when the average thickness is 200 μm or less, decrease in light transmittance tends to be suppressed.

The average thickness of the covering material is obtained as, for example, an arithmetic average value of the thicknesses of random three points measured using a micrometer.

In the wavelength conversion member according to the present disclosure, in the case in which the covering material has the specific surface roughness, the arithmetic average roughness Ra of the covering material is 5 μm or more, and from the viewpoint of impact resistance, the arithmetic average roughness Ra of the covering material is preferably 7 μm or more, and further preferably 9 μm or more. The upper limit of the arithmetic average roughness Ra is not particularly limited, and the arithmetic average roughness Ra may be 50 μm or less.

In the wavelength conversion member according to the present disclosure, in the case in which the covering material has the specific surface roughness, the maximum height Rz of the covering material is from 30 to 250 μm, preferably from 40 to 200 μm, more preferably from 50 to 190 μm, and further preferably from 60 to 180 μm. When the maximum height Rz is 30 μm or more, impact resistance tends to be favorable. Further, when the maximum height Rz is 250 μm or less, its influence on the calculation of the arithmetic average roughness Ra, to the effect that the arithmetic average roughness Ra becomes a superficially large value owing to the large maximum height Rz, can be reduced.

The material of the covering material is not particularly limited, and may be: a polyester, such as polyethylene terephthalate (PET) or polyethylene naphthalate (PEN); a polyolefin, such as polyethylene (PE) or polypropylene (PP); a polyamide, such as nylon; an ethylene-vinyl alcohol copolymer (EVOH), or the like. From the viewpoint of availability, the material of the covering material is preferably at least one selected from the group consisting of polyethylene terephthalate and polypropylene.

The covering material may be one that is provided with a barrier layer (also referred to as a barrier film) for enhancing the barrier function. Examples of the barrier layer include an inorganic layer containing an inorganic material, such as alumina or silica.

The covering material preferably has barrier property against at least one of oxygen or water, and more preferably has a barrier property against both oxygen and water, from the viewpoint of suppressing a decrease in the light emission efficiency of the phosphor. The covering material having a barrier property against at least one of oxygen or water is not particularly limited, and a known covering material such as a barrier film having an inorganic layer can be used.

Oxygen permeability of the covering material is, for example, preferably 1.0 mL/(m²·24 h·atm) or less, more preferably 0.8 mL/(m²·24 h·atm) or less, and further preferably 0.6 mL/(m²·24 h·atm) or less. The oxygen permeability of the covering material can be measured using an oxygen permeability tester (e.g., MOCON, OX-TRAN) under the conditions of a temperature of 23° C. and a relative humidity of 90%.

Further, the water vapor permeability of the covering material is, for example, preferably 1×10° g/(m²·24 h) or less, more preferably 8×10⁻¹ g/(m²·24 h) or less, and further preferably 6×10⁻¹ g/(m²·24 h) or less. The water vapor permeability of the covering material can be measured using a water vapor permeability tester (for example, MOCON, AQUATRAN) under the conditions of a temperature of 40° C. and a relative humidity of 100%.

Wavelength Conversion Layer

The wavelength conversion member according to the present disclosure includes a wavelength conversion layer. The wavelength conversion layer contains a phosphor. The wavelength conversion layer may further contain a cured resin product, or may have a phosphor contained in the cured resin product. Further, the wavelength conversion layer may further contain a light diffusing material.

[Phosphor]

The wavelength conversion layer contains a phosphor that emits light when irradiated with light from a light source. The type of phosphor is not particularly limited, and examples thereof include an organic phosphor and an inorganic phosphor.

Examples of the organic phosphor include a naphthalimide compound and a perylene compound.

Examples of the inorganic phosphor include: a red light-emitting inorganic phosphor, such as Y₃O₃:Eu, YVO₄:Eu, Y₂O₂:Eu, 3.5MgO.0.5MgF₂, GeO₂:Mn, or (Y.Cd)BO₂:Eu; a green light-emitting inorganic phosphor, such as ZnS:Cu.Al, (Zn.Cd)S:Cu. Al, ZnS:Cu.Au.Al, Zn₂SiO₄:Mn, ZnSiO₄:Mn, ZnS:Ag.Cu, (Zn.Cd)S:Cu, ZnS:Cu, GdOS:Tb, LaOS:Tb, YSiO₄:Ce.Tb, ZnGeO₄:Mn, GeMgAlO:Tb, SrGaS:Eu²⁺, ZnS:Cu.Co, MgO.nB₂O₃:Ge.Tb, LaOBr:Tb.Tm, or La₂O₂S:Tb; and a blue light-emitting inorganic phosphor, such as ZnS:Ag, GaWO₄, Y₂SiO₆:Ce, ZnS:Ag.Ga.Cl, Ca₂B₄OCl:Eu²⁺, or BaMgAl₄O₃:Eu²⁺; a quantum dot phosphor; and the like.

As a phosphor, a quantum dot phosphor is preferable from the viewpoint of excellent color reproducibility of an image display device.

The quantum dot phosphor is not particularly limited, and examples thereof include particles containing at least one selected from the group consisting of a group II-VI compound, a group III-V compound, a group IV-VI compound, and a group IV compound. From the viewpoint of light emission efficiency, the quantum dot phosphor preferably contains a compound containing at least one of Cd or In.

Specific examples of the II-VI group compound include CdSe, CdTe, CdS, ZnS, ZnSe, ZnTe, ZnO, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, CdZnSeS, CdZnSeTe, CdZnSTe, CdHgSeS, CdHgSeTe, CdHgSTe, HgZnSeS, HgZnSeTe, and HgZnSTe.

Specific examples of the Group III-V compound include GaN, GaP, GaAs, GaSb, AlN, AlP, AlAs, AlSb, InN, InP, InAs, InSb, GaNP, GaNAs, GaNSb, GaPAs, GaPSb, AlNP, AlNAs, AlNSb, AlPAs, AlPSb, InNP, InNAs, InNSb, InPAs, InPSb, GaAlNP, GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, and InAlPSb.

Specific examples of the IV-VI group compound include SnS, SnSe, SnTe, PbS, PbSe, PbTe, SnSeS, SnSeTe, SnSTe, PbSeS, PbSeTe, PbSTe, SnPbS, SnPbSe, SnPbTe, SnPbSSe, SnPbSeTe, and SnPbSTe.

Specific examples of the Group IV compound include Si, Ge, SiC, and SiGe.

The quantum dot phosphor may have a core-shell structure. By making the band gap of the compound forming the shell wider than the band gap of the compound forming the core, the quantum efficiency of the quantum dot phosphor can be further improved. Examples of the combination of the core and shell (core/shell) include CdSe/ZnS, InP/ZnS, PbSe/PbS, CdSe/CdS, CdTe/CdS, and CdTe/ZnS.

Further, the quantum dot phosphor may have a so-called core multi-shell structure in which the shell has a multi-layer structure. By providing a core having a wide bandgap with one or more layers of shells having a narrow bandgap, and further providing a shell having a wide bandgap on the said one or more layers of shells, the quantum efficiency of the quantum dot phosphor can be further improved.

When the wavelength conversion layer contains a quantum dot phosphor, the wavelength conversion layer may contain one type of quantum dot phosphor alone, or may contain two or more types of quantum dot phosphors in combination. Examples of the aspect in which two or more types of quantum dot phosphors are contained in combination include an aspect in which two or more types of quantum dot phosphors of different materials having the same average particle size are contained, an aspect in which two or more types of quantum dot phosphors of the same material having different average particle sizes are contained, and an aspect in which two or more types of quantum dot phosphors of different materials having different average particle sizes are contained. The central emission wavelength of the quantum dot phosphor can be changed by changing at least one of the material or the average particle size of the quantum dot phosphor.

For example, the wavelength conversion layer may contain a quantum dot phosphor G, which has a central emission wavelength in the green wavelength region of 520 to 560 nm, and a quantum dot phosphor R, which has a central emission wavelength in the red wavelength region of 600 to 680 nm. When the wavelength conversion layer containing the quantum dot phosphor G and the quantum dot phosphor R is irradiated with excitation light in the blue wavelength range of 430 to 480 nm, the quantum dot phosphor G and the quantum dot phosphor R emit green light and red light, respectively. As a result, white light can be achieved by the blue light transmitted through the cured product and the green light and red light emitted from the quantum dot phosphor G and the quantum dot phosphor R.

The content of the phosphor in the wavelength conversion layer is, for example, preferably from 0.01 to 1.0% by mass, more preferably from 0.05 to 0.5% by mass, and further preferably from 0.1 to 0.5% by mass, with respect to the entire wavelength conversion layer. When the content of the phosphor is 0.01% by mass or more with respect to the entire wavelength conversion layer, aggregation of the phosphor tends to be suppressed.

[Cured Resin Product]

The wavelength conversion layer may further contain a cured resin product. The wavelength conversion layer may be a layer in which the above-described phosphor is contained in the cured resin product.

From the viewpoints of adhesion of the cured resin product to other members (e.g., a covering material) and suppression of wrinkles caused by volume shrinkage during the curing, the cured resin product preferably contains a sulfide structure. The cured resin product containing a sulfide structure can be obtained by curing a resin composition containing a thiol compound described later and a polymerizable compound having a carbon-carbon double bond that causes an ene-thiol reaction with a thiol group of the thiol compound.

From the viewpoint of heat resistance and moist heat resistance of the wavelength conversion layer, the cured resin product preferably contains an alicyclic structure or an aromatic ring structure. The cured resin product having an alicyclic structure or an aromatic ring structure can be obtained by, for example, curing a resin composition containing a polymerizable compound having an alicyclic structure or an aromatic ring structure as a polymerizable compound described later.

From the viewpoint of suppressing contact between the phosphor and oxygen, the cured resin product preferably contains an alkyleneoxy group. When the cured resin product contains an alkyleneoxy group, non-polar oxygen is less likely to be dissolved in the components of the cured product since the polarity of the cured resin product is increased. Further, adhesion to the covering material tends to be improved by enhanced flexibility of the cured resin product.

The cured resin product containing an alkyleneoxy group can be obtained by, for example, curing a resin composition containing a polymerizable compound having an alkyleneoxy group as a polymerizable compound described later.

—Resin Composition—

The wavelength conversion layer may be a cured product of a composition (hereinafter, also simply referred to as a resin composition) containing a phosphor, a polymerizable compound, and a photopolymerization initiator. The resin composition preferably contains a phosphor, a thiol compound, at least one selected from the group consisting of a (meth)acrylic compound and a (meth)allyl compound, and a photopolymerization initiator. The resin composition may optionally contain other components.

Hereinafter, each component of the resin composition will be described in detail.

(Phosphor)

The resin composition contains a phosphor. The details of the phosphor are as described above.

When a quantum dot phosphor is used as a phosphor, the quantum dot phosphor may be used in a form of a quantum dot phosphor dispersion liquid in which the phosphor is dispersed in a dispersion medium. Examples of the dispersion medium for dispersing the quantum dot phosphor include various organic solvents, a silicone compound, and a monofunctional (meth)acrylate compound. The quantum dot may be used in a form of a quantum dot phosphor dispersion liquid using a dispersant as necessary.

The organic solvent that can be used as a dispersion medium is not particularly limited as long as precipitation and aggregation of the quantum dot phosphor are not observed, and examples thereof include acetonitrile, methanol, ethanol, acetone, 1-propanol, ethyl acetate, butyl acetate, toluene, and hexane.

The silicone compound that can be used as a dispersion medium include a straight silicone oil, such as dimethyl silicone oil, methylphenyl silicone oil, and methylhydrogen silicone oil; and a modified silicone oil, such as an amino-modified silicone oil, an epoxy-modified silicone oil, a carboxy-modified silicone oil, a carbinol-modified silicone oil, a mercapto-modified silicone oil, a heterogeneous functional group-modified silicone oil, a polyether-modified silicone oil, a methylstyryl-modified silicone oil, a hydrophilic specially-modified silicone oil, a higher alkoxy-modified silicone oil, a higher fatty acid-modified silicone oil, or a fluorine-modified silicone oil.

The monofunctional (meth)acrylate compound that can be used as a dispersion medium is not particularly limited as long as it is liquid at room temperature (25° C.), and examples thereof include a monofunctional (meth)acrylate compound having an alicyclic structure (preferably isobornyl (meth)acrylate or dicyclopentanyl (meth)acrylate), methoxypolyethylene glycol (meth)acrylate, phenoxypolyethylene glycol (meth)acrylate, and ethoxylated o-phenylphenol (meth)acrylate.

Examples of the dispersant used as necessary include polyether amine (JEFFAMINE M-1000, Huntsman Corporation) and oleic acid.

The mass-based content of the quantum dot phosphor with respect to the quantum dot phosphor dispersion liquid is preferably from 1 to 20% by mass, and more preferably from 1 to 10% by mass.

The content of the quantum dot phosphor dispersion liquid in the resin composition is, when the mass-based content of the quantum dot phosphor with respect to the quantum dot phosphor dispersion liquid is from 1 to 20% by mass, for example, preferably from 1 to 10% by mass, more preferably from 4 to 10% by mass, and further preferably from 4 to 7% by mass, with respect to the total amount of the resin composition.

The content of the quantum dot phosphor in the resin composition is, for example, preferably from 0.01 to 1.0% by mass, more preferably from 0.05 to 0.5% by mass, and further preferably from 0.1 to 0.5% by mass, with respect to the total amount of the resin composition. When the content of the quantum dot phosphor is 0.01% by mass or more, sufficient emission intensity tends to be obtained when the cured product is irradiated with excitation light, and when the content of the quantum dot phosphor is 1.0% by mass or less, aggregation of the quantum dot phosphor tends to be suppressed.

(Polymerizable Compound)

The resin composition contains a polymerizable compound. The polymerizable compound contained in the resin composition is not particularly limited, and examples thereof include a thiol compound, a (meth)acrylic compound, and a (meth)allyl compound. The (meth)allyl compound means a compound having a (meth)allyl group in the molecule, and the (meth)acrylic compound means a compound having a (meth)acryloyl group in the molecule. For convenience, a compound having both a (meth)allyl group and a (meth)acryloyl group in the molecule is categorized as a (meth)allyl compound.

From the viewpoint of adhesion of the wavelength conversion layer to other members (e.g., a covering material), the resin composition preferably contains a thiol compound and at least one selected from the group consisting of a (meth)acrylic compound and a (meth)allyl compound as polymerizable compounds.

A cured product obtained by curing a resin composition containing a thiol compound and at least one selected from the group consisting of a (meth)acrylic compound and a (meth)allyl compound as polymerizable compounds contains sulfide structures (R—S—R′, in which each of R and R′ represents an organic group) formed by progression of ene-thiol reactions between thiol groups and carbon-carbon double bonds of the (meth)acryloyl groups or (meth)allyl groups. This tends to improve adhesion between the wavelength conversion layer and the covering material. Further, this tends to improve optical property of the wavelength conversion layer.

Hereinafter, the thiol compound, the (meth)acrylic compound, and the (meth)allyl compound will be described in detail.

A. Thiol Compound

The thiol compound may be a monofunctional thiol compound having one thiol group in a molecule thereof or a polyfunctional thiol compound having two or more thiol groups in a molecule thereof. One type of thiol compound may be contained in the resin composition, or two or more types thereof may be contained in the resin composition.

The thiol compound may or may not have a polymerizable group other than the thiol group (e.g., a (meth)acryloyl group, a (meth)allyl group) in the molecule.

In the present disclosure, a compound having a thiol group and a polymerizable group other than the thiol group in the molecule is categorized as a “thiol compound”.

Specific examples of the monofunctional thiol compound include hexanethiol, 1-heptanethiol, 1-octanethiol, 1-nonanthiol, 1-decanethiol, 3-mercaptopropionic acid, methyl mercaptopropionate, methoxybutyl mercaptopropionate, octyl mercaptopropionate, tridecyl mercaptopropionate, 2-ethylhexyl-3-mercaptopropionate, and n-octyl-3-mercaptopropionate.

Specific examples of the polyfunctional thiol compound include ethylene glycol bis(3-mercaptopropionate), diethylene glycol bis(3-mercaptopropionate), tetraethylene glycol bis(3-mercaptopropionate), 1,2-.propropylene glycol bis(3-mercaptopropionate), diethylene glycol bis(3-mercaptobutyrate), 1,4-butanediol bis(3-mercaptopropionate), 1,4-butanediol bis(3-mercaptobutyrate), 1,8-octanediol bis(3-mercaptopropionate), 1,8-octanediol bis(3-mercaptobutyrate), hexanediol bisthioglycolate, trimethylolpropane tris(3-mercaptopropionate), trimethylolpropane tris(3-mercaptobutyrate), trimethylolpropane tris(3-mercaptoisobutyrate), trimethylolpropane tris(2-mercaptoisobutyrate), trimethylolpropane tristhioglycolate, tris-[(3-mercaptopropionyloxy)-ethyl]-isocyanurate, trimethylolethane tris(3-mercaptobutyrate), pentaerythritol tetrakis(3-mercaptopropionate), pentaerythritol tetrakis(3-mercaptobutyrate), pentaerythritol tetrakis(3-mercaptoisobutyrate), pentaerythritol tetrakis(2-mercaptoisobutyrate), dipentaerythritol hexakis(3-mercaptopropionate), dipentaerythritol hexakis(2-mercaptopropionate), dipentaerythritol hexakis(3-mercaptobutyrate), dipentaerythritol hexakis(3-mercaptoisobutyrate), dipentaerythritol hexakis(2-mercaptoisobutyrate), pentaerythritol tetrakis thioglycolate, and dipentaerythritol hexakis thioglycolate.

From the viewpoint of further improving heat resistance, moist heat resistance and adhesion between the wavelength conversion layer and the covering material, the thiol compound preferably includes a polyfunctional thiol compound. The content of the polyfunctional thiol compound with respect to the total amount of the thiol compound is, for example, preferably 80% by mass or more, more preferably 90% by mass or more, and further preferably 100% by mass.

The thiol compound may be in a form of a thioether oligomer formed by a reaction with a (meth)acrylic compound. The thioether oligomer can be obtained by addition polymerization of a thiol compound and a (meth)acrylic compound in the presence of a polymerization initiator.

When the resin composition contains a thiol compound, the content of the thiol compound in the resin composition is preferably, for example, from 5 to 80% by mass, more preferably from 15 to 70% by mass, and further preferably from 20 to 60% by mass, with respect to the total amount of the resin composition.

When the content of the thiol compound is 5% by mass or more, the adhesion of the wavelength conversion layer to the covering material tends to be further improved, and when the content of the thiol compound is 80% by mass or less, heat resistance and moist heat resistance of the wavelength conversion layer tend to be further improved.

B. (Meta)acrylic Compound

The (meth)acrylic compound may be a monofunctional (meth)acrylic compound having one (meth)acryloyl group in a molecule thereof, or may be a polyfunctional (meth)acrylic compound having two or more (meth)acryloyl groups in a molecule thereof. One kind of (meth)acrylic compound may be contained in the resin composition, or two or more kinds of (meth)acrylic compounds may be contained in the resin composition.

Specific examples of the monofunctional (meth)acrylic compound include: (meth)acrylic acid; an alkyl (meth)acrylate compound having an alkyl group having 1 to 18 carbon atoms, such as methyl (meth)acrylate, n-butyl (meth)acrylate, isobutyl (meth)acrylate, 2-ethylhexyl (meth)acrylate, isononyl (meth)acrylate, n-octyl (meth)acrylate, lauryl (meth)acrylate, or stearyl (meth)acrylate; a (meth)acrylate compound having an aromatic ring, such as benzyl (meth)acrylate, or phenoxyethyl (meth)acrylate; an alkoxyalkyl (meth)acrylate, such as butoxyethyl (meth)acrylate; an aminoalkyl (meth)acrylate, such as N, N-dimethylaminoethyl (meth)acrylate; a polyalkylene glycol monoalkyl ether (meth)acrylate, such as diethylene glycol monoethyl ether (meth)acrylate, triethylene glycol monobutyl ether (meth)acrylate, tetraethylene glycol monomethyl ether (meth)acrylate, hexaethylene glycol monomethyl ether (meth)acrylate, octaethylene glycol monomethyl ether (meth)acrylate, nonaethylene glycol monomethyl ether (meth)acrylate, dipropylene glycol monomethyl ether (meth)acrylate, heptapropylene glycol monomethyl ether (meth)acrylate, or tetraethylene glycol monoethyl ether (meth)acrylate; a polyalkylene glycol monoaryl ether (meth)acrylate, such as hexaethylene glycol monophenyl ether (meth)acrylate; a (meth)acrylate compound having an alicyclic structure, such as cyclohexyl (meth)acrylate, dicyclopentanyl (meth)acrylate, isobornyl (meth)acrylate, or methylene oxide-adduct cyclodecatriene (meth)acrylate; a (meth)acrylate compound having a heterocyclic ring, such as (meth)acryloylmorpholin or tetrahydrofurfuryl (meth)acrylate; a fluoroalkyl (meth)acrylate, such as heptadecafluorodecyl (meth)acrylate; a (meth)acrylate compound having a hydroxy group, such as 2-hydroxyethyl (meth)acrylate, 3-hydroxypropyl (meth)acrylate, 4-hydroxybutyl (meth)acrylate, triethylene glycol mono(meth)acrylate, tetraethylene glycol mono(meth)acrylate, hexaethylene glycol mono(meth)acrylate, or octapropylene glycol mono(meth)acrylate; a (meth)acrylate compound having a glycidyl group, such as glycidyl (meth)acrylate; a (meth)acrylate compound having an isocyanate group, such as 2-(2-(meth)acryl oyloxyethyloxy)ethyl isocyanate or 2-(meth)acryloyloxyethyl isocyanate; a polyalkylene glycol mono(meth)acrylate, such as tetraethylene glycol mono(meth)acrylate, hexaethylene glycol mono(meth)acrylate, or octapropylene glycol mono(meth)acrylate; and a (meth)acrylamide compound, such as (meth)acrylamide, N,N-dimethyl (meth)acrylamide, N-isopropyl (meth)acrylamide, N,N-dimethylaminopropyl (meth)acrylamide, N,N-diethyl (meth)acrylamide, or 2-hydroxyethyl (meth)acrylamide.

Specific examples of the polyfunctional (meth)acrylic compound include: an alkylene glycol di(meth)acrylate, such as 1,4-butanediol di(meth)acrylate, 1,6-hexanediol di(meth)acrylate, or 1,9-nonanediol di(meth)acrylate; a polyalkylene glycol di(meth)acrylate, such as polyethylene glycol di(meth)acrylate or polypropylene glycol di(meth)acrylate; a tri(meth)acrylate compound, such as trimethylolpropane tri(meth)acrylate, ethylene oxide-adduct trimethylolpropane tri(meth)acrylate, or tris(2-acryloyloxyethyl) isocyanurate; a tetra(meth)acrylate compound, such as ethylene oxide-adduct pentaerythritol tetra(meth)acrylate, trimethylolpropane tetra(meth)acrylate, or pentaerythritol tetra(meth)acrylate; a (meth)acrylate compound having an alicyclic structure, such as tricyclodecanedimethanol di(meth)acrylate, cyclohexanedimethanol di(meth)acrylate, 1,3-adamantane dimethanol di(meth)acrylate, hydrogenated bisphenol A (poly)ethoxy di(meth)acrylate, hydrogenated bisphenol A (poly)propoxy di(meth)acrylate, hydrogenated bisphenol F (poly)ethoxy di(meth)acrylate, hydrogenated bisphenol F (poly)propoxy di(meth)acrylate, hydrogenated bisphenol S (poly)ethoxy di(meth)acrylate, or hydrogenated bisphenol S (poly)propoxy di(meth)acrylate.

From the viewpoint of further improving heat resistance and moist heat resistance of the cured product, a (meth)acrylate compound having an alicyclic structure or an aromatic ring structure is preferable. Examples of the alicyclic structure or the aromatic ring structure include an isobornyl skeleton, a tricyclodecane skeleton, and a bisphenol skeleton.

The (meth)acrylic compound may have an alkyleneoxy group, and may be a bifunctional (meth)acrylic compound having an alkyleneoxy group.

As the alkyleneoxy group, for example, an alkyleneoxy group having 2 to 4 carbon atoms is preferable, an alkyleneoxy group having 2 or 3 carbon atoms is more preferable, and an alkyleneoxy group having 2 carbon atoms is further preferable.

The (meth)acrylic compound may have one type of alkyleneoxy group or two or more types of alkyleneoxy groups.

The alkyleneoxy group-containing compound may be a polyalkyleneoxy group-containing compound having a polyalkyleneoxy group that contains plural alkyleneoxy groups.

When the (meth)acrylic compound has an alkyleneoxy group, the number of alkyleneoxy groups in one molecule is preferably from 2 to 30, more preferably from 2 to 20, further preferably from 3 to 10, and particularly preferably from 3 to 5.

When the (meth)acrylic compound has an alkyleneoxy group, the (meth)acrylic compound preferably has a bisphenol structure. This tends to improve heat resistance of the cured product. Examples of the bisphenol structure include a bisphenol A structure and a bisphenol F structure, and in particular, a bisphenol A structure is preferable.

Specific examples of the (meth)acrylic compound having an alkyleneoxy group include: an alkoxyalkyl (meth)acrylate, such as butoxyethyl (meth)acrylate; a polyalkylene glycol monoalkyl ether (meth)acrylate, such as diethylene glycol monoethyl ether (meth)acrylate, triethylene glycol monobutyl ether (meth)acrylate, tetraethylene glycol monomethyl ether (meth)acrylate, hexaethylene glycol monomethyl ether (meth)acrylate, octaethylene glycol monomethyl ether (meth)acrylate, nonaethylene glycol monomethyl ether (meth)acrylate, dipropylene glycol monomethyl ether (meth)acrylate, heptapropylene glycol monomethyl ether (meth)acrylate, or tetraethylene glycol monoethyl ether (meth)acrylate; a polyalkylene glycol monoaryl ether (meth)acrylate, such as hexaethylene glycol monophenyl ether (meth)acrylate; a (meth)acrylate compound having a heterocyclic ring, such as tetrahydrofurfuryl (meth)acrylate; a (meth)acrylate compound having a hydroxy group, such as triethylene glycol mono(meth)acrylate, tetraethylene glycol mono(meth)acrylate, hexaethylene glycol mono(meth)acrylate, or octapropylene glycol mono(meth)acrylate; a (meth)acrylate compound having a glycidyl group, such as glycidyl (meth)acrylate; a polyalkylene glycol di(meth)acrylate, such as polyethylene glycol di(meth)acrylate or polypropylene glycol di(meth)acrylate; a tri(meth)acrylate compound, such as ethylene oxide-adduct trimethylolpropane tri(meth)acrylate; a tetra(meth)acrylate compound, such as ethylene oxide-adduct pentaerythritol tetra(meth)acrylate; and a bisphenol-type di(meth)acrylate compound, such as ethoxylated bisphenol A-type di(meth)acrylate, propoxylated bisphenol A-type di(meth)acrylate, or propoxylated-ethoxylated bisphenol A-type di(meth)acrylate.

As the alkyleneoxy group-containing compound, in particular, ethoxylated bisphenol A-type di(meth)acrylate, propoxylated bisphenol A-type di(meth)acrylate, and propoxylated-ethoxylated bisphenol A-type di(meth)acrylate are preferable, and ethoxylated bisphenol A-type di(meth)acrylate is more preferable.

When the resin composition contains a (meth)acrylic compound, the content of the (meth)acrylic compound in the resin composition may be, for example, from 40 to 90% by mass or from 50 to 80% by mass, with respect to the total amount of the resin composition.

C. (Meta)allyl Compound

The (meth)allyl compound may be a monofunctional (meth)allyl compound having one (meth)allyl group in a molecule thereof, or may be a multifunctional (meth)allyl compound having two or more (meth)allyl groups in a molecule thereof. The resin composition may contain one type of (meth)allyl compound or may contain two or more types of (meth)allyl compounds.

The (meth)allyl compound may or may not have a polymerizable group other than the (meth)allyl group (e.g., a (meth)acryloyl group) in the molecule.

In the present disclosure, the compound having a polymerizable group other than the (meth)allyl group (except for the thiol compound) is categorized as a “(meth)allyl compound”.

Specific examples of the monofunctional (meth)allyl compound include (meth)allyl acetate, (meth)allyl n-propionate, (meth)allyl benzoate, (meth)allyl phenylacetate, (meth)allyl phenoxyacetate, (meth)allyl methyl ether, and (meth)allyl glycidyl ether.

Specific examples of the multifunctional (meth)allyl compound include di(meth)allyl benzenedicarboxylate, di(meth)allyl cyclohexanedicarboxylate, di(meth)allyl maleate, di(meth)allyl adipate, di(meth)allyl phthalate, di(meth)allyl isophthalate, di(meth)allyl terephthalate, glycerin di(meth)allyl ether, trimethylolpropane di(meth)allyl ether, pentaerythritol di(meth)allyl ether, 1,3-di(meth)allyl-5-glycidyl isocyanurate, tri(meth)allyl cyanurate, tri(meth)allyl isocyanurate, tri(meth)allyl trimellitate, tetra(meth)allyl pyromellitate, 1,3,4,6-tetra(meth)allylglycoluril, 1,3,4,6-tetra(meth)allyl-3a-methylglycoluril, and 1,3,4,6-tetra(meth)allyl-3a,6a-dimethylglycoluril.

From the viewpoint of heat resistance and moist heat resistance of the cured product, the (meth)allyl compound is preferably at least one selected from the group consisting of: a compound having an isocyanurate skeleton, such as tri(meth)allyl isocyanurate; tri(meth)allyl cyanurate; di(meth)allyl benzenedicarboxylate; and di(meth)allyl cyclohexanedicarboxylate, more preferably a compound having an isocyanurate skeleton, and further preferably tri(meth)allyl isocyanurate.

When the resin composition contains a (meth)allyl compound, the content of the (meth)allyl compound in the resin composition may be, for example, from 10 to 50% by mass or from 15 to 45% by mass, with respect to the total amount of the resin composition.

In an embodiment, the polymerizable compound may include a thioether oligomer as a thiol compound and a (meth)allyl compound (preferably a multifunctional (meth)allyl compound).

When the polymerizable compound include a thioether oligomer as a thiol compound and a (meth)allyl compound, and a quantum dot phosphor is used as a phosphor, the quantum dot phosphor is preferably in a form of a dispersion liquid in which the quantum dot phosphor is dispersed in a silicone compound as a dispersion medium.

In an embodiment, the polymerizable compound may include a thiol compound that is not in the form of a thioether oligomer and a (meth)acrylic compound (preferably a multifunctional (meth)acrylic compound, and more preferably a bifunctional (meth)acrylic compound).

When the polymerizable compound include a thiol compound that is not in the form a thioether oligomer and a (meth)acrylic compound, and a quantum dot phosphor is used as a phosphor, the quantum dot phosphor is preferably in a form of a dispersion liquid in which the quantum dot phosphor is dispersed in a (meth)acrylic compound, preferably a monofunctional (meth)acrylic compound, and more preferably isobornyl (meth)acrylate, as a dispersion medium.

(Photopolymerization Initiator)

The type of photopolymerization initiator contained in the resin composition is not particularly limited, and examples thereof include a compound that generates radicals in response to the irradiation of active energy rays such as UV rays.

Specific examples of the photopolymerization initiator include an aromatic ketone compound, such as benzophenone, N,N′-tetraalkyl-4,4′-diaminobenzophenone, 2-benzyl-2-dimethylamino-1-(4-morpholinophenyl)-butanone-1,2-methyl-1-[4-(methylthio)phenyl]-2-morpholino-propanone-1,4,4′-bis(dimethylamino)benzophenone (also referred to as “Michler's ketone”), 4,4′-bis(diethylamino)benzophenone, 4-methoxy-4′-dimethylaminobenzophenone, 1-hydroxycyclohexyl phenyl ketone, 1-(4-isopropylphenyl)-2-hydroxy-2-methylpropan-1-one, 1-(4-(2-hydroxyethoxy)-phenyl)-2-hydroxy-2-methyl-1-propan-1-one, or 2-hydroxy-2-methyl-1-phenylpropan-1-one; a quinone compound, such as an alkylanthraquinone or phenanthrenequinone; a benzoin compound, such as benzoin or an alkylbenzoin; a benzoin ether compound, such as a benzoin alkyl ether or benzoin phenyl ether; a benzyl derivative, such as benzyl dimethyl ketal; a 2,4,5-triarylimidazole dimer, such as a 2-(o-chlorophenyl)-4,5-diphenylimidazole dimer, a 2-(o-chlorophenyl)-4,5-di(m-methoxyphenyl)imidazole dimer, a 2-(o-fluorophenyl)-4,5-diphenylimidazole dimer, a 2-(o-methoxyphenyl)-4,5-diphenylimidazole dimer, a 2,4-di(p-methoxyphenyl)-5-phenylimidazole dimer, or a 2-(2,4-dimethoxyphenyl)-4,5-diphenylimidazole dimer; an acridine derivative, such as 9-phenylacridine or 1,7-(9,9′-acridinyl)heptane; an oxime ester compound, such as 1,2-octanedione 1-[4-(phenylthio)-2-(O-benzoyloxime)] or ethanone 1-[9-ethyl-6-(2-methylbenzoyl)-9H-carbazol-3-yl]-1-(O-acetyloxime); a coumarin compound, such as 7-diethylamino-4-methylcoumarin; a thioxanthone compound, such as 2,4-diethylthioxanthone; and an acylphosphine oxide compound, such as 2,4,6-trimethylbenzoyl-diphenyl-phosphine oxide or 2,4,6-trimethylbenzoyl-phenyl-ethoxy-phosphine oxide. The resin composition may contain one type of photopolymerization initiator or may contain two or more types of photopolymerization initiators in combination.

As the photopolymerization initiator, at least one selected from the group consisting of an acylphosphine oxide compound, an aromatic ketone compound, and an oxime ester compound is preferable, at least one selected from the group consisting of an acylphosphine oxide compound and an aromatic ketone compound is more preferable, and an acylphosphine oxide compound is further preferable, from the viewpoint of curability.

The content of the photopolymerization initiator in the resin composition is preferably, for example, from 0.1 to 5% by mass, more preferably from 0.1 to 3% by mass, and further preferably from 0.5 to 1.5% by mass, with respect to the total amount of the resin composition. When the content of the photopolymerization initiator is 0.1% by mass or more, sensitivity of the resin composition tends to be sufficient, and when the content of the photopolymerization initiator is 5% by mass or less, its influence on the hue of the resin composition and deterioration in the storage stability tend to be suppressed.

(Light Diffusion Material)

From the viewpoint of improving light conversion efficiency, the resin composition may further contain a light diffusion material. Specific examples of the light diffusion material include titanium oxide, barium sulfate, zinc oxide, and calcium carbonate. In particular, titanium oxide is preferable from the viewpoint of light scattering efficiency. The titanium oxide may be rutile-type titanium oxide or anatase-type titanium oxide, and is preferably rutile-type titanium oxide.

The average particle size of the light diffusion material is preferably from 0.1 to 1 μm, more preferably from 0.2 to 0.8 and further preferably from 0.2 to 0.5

In the present disclosure, the average particle size of the light diffusion material can be measured as follows.

When the light diffusion material is contained in a resin composition, the light diffusion material that has been extracted is dispersed in purified water containing a surfactant to obtain a dispersion liquid. In a volume-based particle size distribution obtained by a laser diffraction particle size distribution analyzer (e.g., Shimadzu Corporation, SALD-3000J) using the dispersion liquid, the value at which the integrated volume from the side of small particles reaches 50% (median diameter (D50)) is regarded as an average particle size of the light diffusion material. As for the method of extracting the light diffusion material, the light diffusion material can be obtained by, for example, diluting the resin composition with a liquid medium and precipitating the light diffusion material by centrifugation process or the like for collection.

The average particle size of the light diffusion material in a cured product obtained by curing a resin composition containing the light diffusion material can be obtained by taking the arithmetic average of the equivalent circle diameters (geometric average of the major diameter and the minor diameter) calculated for 50 particles observed by a scanning electron microscope.

From the viewpoint of suppressing aggregation of the light diffusion material in the resin composition, the light diffusion material preferably has an organic material layer containing an organic material at at least a part of the surface. Examples of the organic material contained in the organic material layer include an organosilane, an organosiloxane, a fluorosilane, an organophosphonate, an organic phosphoric acid compound, an organic phosphinate, an organic sulfonic acid compound, a carboxylic acid, a carboxylate ester, a derivative of a carboxylic acid, an amide, a hydrocarbon wax, a polyolefin, a polyolefin copolymer, a polyol, a derivative of a polyol, an alkanolamine, a derivative of an alkanolamine, and an organic dispersant.

The organic material contained in the organic material layer preferably includes a polyol, an organosilane, or the like, and more preferably includes at least one of a polyol or an organosilane.

Specific examples of the organosilane include octyltriethoxysilane, nonyltriethoxysilane, decyltriethoxysilane, dodecyltriethoxysilane, tridecyltriethoxysilane, tetradecyltriethoxysilane, pentadecyltriethoxysilane, hexadecyltriethoxysilane, heptadecyltriethoxysilane, and octadecyltriethoxysilane.

Specific examples of the organosiloxane include trimethylsilyl group-terminated polydimethylsiloxane (PDMS), polymethylhydrosiloxane (PMHS), and a polysiloxane derived from functionalization (by hydrosilylation) of PMHS with an olefin.

Specific examples of the organophosphonate include, for example, n-octylphosphonic acid and an ester thereof, n-decylphosphonic acid and an ester thereof, 2-ethylhexylphosphonic acid and an ester thereof, and camphyl phosphonic acid and an ester thereof.

Specific examples of the organic phosphoric acid compound include an organic acidic phosphate, an organic pyrophosphate, an organic polyphosphate, an organic metaphosphate, and a salt thereof.

Specific examples of the organic phosphinate include, for example, n-hexyl phosphinic acid and an ester thereof, n-octylphosphinic acid and an ester thereof, di-n-hexylphosphinic acid and an ester thereof, and di-n-octylphosphinic acid and an ester thereof.

Specific examples of the organic sulfonic acid compound include an alkyl sulfonic acid, such as hexylsulfonic acid, octylsulfonic acid, and 2-ethylhexylsulfonic acid; and a salt of any of these alkyl sulfonic acids and, for example, a metal ion, such as an sodium ion, calcium ion, magnesium ion, aluminum ion, or titanium ion, an ammonium ion, or an organic ammonium ion, such as an triethanolamine ion.

Specific examples of the carboxylic acid include maleic acid, malonic acid, fumaric acid, benzoic acid, phthalic acid, stearic acid, oleic acid, and linoleic acid.

Specific examples of the carboxylate ester include an ester or a partial ester generated by a reaction between any of the carboxylic acid described above and a hydroxy compound, such as ethylene glycol, propylene glycol, trimethylolpropane, diethanolamine, triethanolamine, glycerol, hexanetriol, erythritol, mannitol, sorbitol, pentaerythritol, bisphenol A, hydroquinone, or phloroglucinol.

Specific examples of the amide include stearic acid amide, oleic acid amide, and erucic acid amide.

Specific examples of the polyolefin and a copolymer thereof include polyethylene, polypropylene, and a copolymer of ethylene and one or more compounds selected from propylene, butylene, vinyl acetate, acrylate, acrylamide, or the like.

Specific examples of the polyol include glycerol, trimethylolethane, and trimethylolpropane.

Specific examples of the alkanolamine include diethanolamine and triethanolamine.

Specific examples of the organic dispersant include citric acid, polyacrylic acid, polymethacrylic acid, and a polymer organic dispersant having a functional group such as an anionic, cationic, zwitterionic, or nonionic functional group.

By suppressing aggregation of the light diffusion material in the resin composition, dispersibility of the light diffusion material in the cured product tends to be improved.

The light diffusion material may have a metal oxide layer containing a metal oxide on at least a part of the surface thereof. Examples of the metal oxide contained in the metal oxide layer include silicon dioxide, aluminum oxide, zirconia, phosphoria, and boria. The metal oxide layer may be single layered or may include two or more layers. In a case in which the light diffusion material has two metal oxide layers, the light diffusion material preferably has a first metal oxide layer containing silicon dioxide and a second metal oxide layer containing aluminum oxide.

By the light diffusion material having a metal oxide layer, dispersibility of the light diffusion material in the cured product tends to be improved.

In a case in which the light diffusion material has an organic material layer containing an organic material and a metal oxide layer, it is preferable that the metal oxide layer and the organic material layer are provided on the surface of the light diffusion material in the order of the metal oxide layer and the organic material layer.

In a case in which the light diffusion material has an organic material layer and two-layered metal oxide layer, it is preferable that a first metal oxide layer containing silicon dioxide, a second metal oxide layer containing aluminum oxide, and an organic material layer are provided on the surface of the light diffusion material in the order of the first metal oxide layer, the second metal oxide layer, and the organic material layer (the organic material layer being the outermost layer).

When the resin composition contains a light diffusion material, the content of the light diffusion material in the wavelength conversion layer formed by curing the resin composition is, for example, preferably from 0.1 to 1.0% by mass, more preferably from 0.2 to 1.0% by mass, and further preferably from 0.3 to 1.0% by mass, with respect to the total mass of the wavelength conversion layer.

(Liquid Medium)

The resin composition may further contain a liquid medium. A liquid medium refers to a medium in the liquid state at room temperature (25° C.).

Examples of the liquid medium include: a ketone solvent, such as acetone, methyl ethyl ketone, methyl-n-propyl ketone, methyl isopropyl ketone, methyl-n-butyl ketone, methyl isobutyl ketone, methyl-n-pentyl ketone, methyl-n-hexyl ketone, diethyl ketone, dipropyl ketone, diisobutyl ketone, trimethylnonane, cyclohexanone, cyclopentanone, methyl cyclohexanone, 2,4-pentanedione, or acetonylacetone; an ether solvent, such as diethyl ether, methyl ethyl ether, methyl-n-propyl ether, diisopropyl ether, tetrahydrofuran, methyl tetrahydrofuran, dioxane, dimethyl dioxane, ethylene glycol dimethyl ether, ethylene glycol diethyl ether, ethylene glycol di-n-propyl ether, ethylene glycol di-n-butyl ether, diethylene glycol dimethyl ether, diethylene glycol diethyl ether, diethylene glycol methyl ethyl ether, diethylene glycol methyl-n-propyl ether, diethylene glycol methyl n-butyl ether, diethylene glycol di-n-propyl ether, diethylene glycol di-n-butyl ether, diethylene glycol methyl-n-hexyl ether, triethylene glycol dimethyl ether, triethylene glycol diethyl ether, triethylene glycol methyl ethyl ether, triethylene glycol methyl n-butyl ether, triethylene glycol di-n-butyl ether, triethylene glycol methyl n-hexyl ether, tetraethylene glycol dimethyl ether, tetraethylene glycol diethyl ether, tetraethylene glycol methyl ethyl ether, tetraethylene glycol methyl n-butyl ether, tetraethylene glycol di-n-butyl ether, tetraethylene glycol methyl n-hexyl ether, propylene glycol dimethyl ether, propylene glycol diethyl ether, propylene glycol di-n-propyl ether, propylene glycol di-n-butyl ether, dipropylene glycol dimethyl ether, dipropylene glycol diethyl ether, dipropylene glycol methyl ethyl ether, dipropylene glycol methyl n-butyl ether, dipropylene glycol di-n-propyl ether, dipropylene glycol di-n-butyl ether, dipropylene glycol methyl n-hexyl ether, tripropylene glycol dimethyl ether, tripropylene glycol diethyl ether, tripropylene glycol methyl ethyl ether, tripropylene glycol methyl n-butyl ether, tripropylene glycol di-n-butyl ether, tripropylene glycol methyl n-hexyl ether, tetrapropylene glycol dimethyl ether, tetrapropylene glycol diethyl ether, tetrapropylene glycol methyl ethyl ether, tetrapropylene glycol methyl n-butyl ether, tetrapropylene glycol di-n-butyl ether, or tetrapropylene glycol methyl n-hexyl ether; a carbonate solvent, such as propylene carbonate, ethylene carbonate, or diethyl carbonate; an ester solvent, such as methyl acetate, ethyl acetate, n-propyl acetate, isopropyl acetate, n-butyl acetate, isobutyl acetate, sec-butyl acetate, n-pentyl acetate, sec-pentyl acetate, 3-methoxybutyl acetate, methylpentyl acetate, 2-ethylbutyl acetate, 2-ethylhexyl acetate, 2-(2-butoxyethoxy)ethyl acetate, benzyl acetate, cyclohexyl acetate, methylcyclohexyl acetate, nonyl acetate, methyl acetoacetate, ethyl acetoacetate, diethylene glycol methyl ether acetate, diethylene glycol monoethyl ether acetate, dipropylene glycol methyl ether acetate, dipropylene glycol ethyl ether acetate, glycol diacetate, methoxytriethylene glycol acetate, ethyl propionate, n-butyl propionate, isoamyl propionate, diethyl oxalate, di-n-butyl oxalate, methyl lactate, ethyl lactate, n-butyl lactate, n-amyl lactate, ethylene glycol methyl ether propionate, ethylene glycol ethyl ether propionate, ethylene glycol methyl ether acetate, ethylene glycol ethyl ether acetate, propylene glycol methyl ether acetate, propylene glycol ethyl ether acetate, propylene glycol propyl ether acetate, γ-butyrolactone, or γ-valerolactone; an aprotic polar solvent, such as acetonitrile, N-methylpyrrolidinone, N-ethylpyrrolidinone, N-propylpyrrolidinone, N-butylpyrrolidinone, N-hexylpyrrolidinone, N-cycl ohexylpyrrolidinone, N,N-dimethylformamide, N,N-dimethyl acetamide, or dimethyl sulfoxide; an alcohol solvent, such as methanol, ethanol, n-propanol, isopropanol, n-butanol, isobutanol, sec-butanol, t-butanol, n-pentanol, isopentanol, 2-methylbutanol, sec-pentanol, t-pentanol, 3-methoxybutanol, n-hexanol, 2-methylpentanol, sec-hexanol, 2-ethylbutanol, sec-heptanol, n-octanol, 2-ethylhexanol, sec-octanol, n-nonyl alcohol, n-decanol, sec-undecyl alcohol, trimethyl nonyl alcohol, sec-tetradecyl alcohol, sec-heptadecyl alcohol, cyclohexanol, methyl cyclohexanol, benzyl alcohol, ethylene glycol, 1,2-propylene glycol, 1,3-butylene glycol, diethylene glycol, dipropylene glycol, triethylene glycol, or tripropylene glycol; a glycol monoether solvent, such as ethylene glycol monomethyl ether, ethylene glycol monoethyl ether, ethylene glycol monophenyl ether, diethylene glycol monomethyl ether, diethylene glycol monoethyl ether, diethylene glycol mono-n-butyl ether, diethylene glycol mono-n-hexyl ether, triethylene glycol monoethyl ether, tetraethylene glycol mono-n-butyl ether, propylene glycol monomethyl ether, dipropylene glycol monomethyl ether, dipropylene glycol monoethyl ether, or tripropylene glycol monomethyl ether; a terpene solvent, such as terpinene, terpineol, myrcene, alloocimene, limonene, dipentene, pinene, carvone, ocimene, or phellandrene; a straight silicone oil, such as dimethyl silicone oil, methyl phenyl silicone oil, or methyl hydrogen silicone oil; a modified silicone oil, such as an amino-modified silicone oil, an epoxy-modified silicone oil, a carboxy-modified silicone oil, a carbinol-modified silicone oil, a mercapto-modified silicone oil, a heterogeneous functional group-modified silicone oil, a polyether-modified silicone oil, a methylstyryl-modified silicone oil, a hydrophilic specially-modified silicone oil, a higher alkoxy-modified silicone oil, a higher fatty acid-modified silicone oil, or a fluorine-modified silicone oil; a saturated aliphatic monocarboxylic acid having 4 or more carbon atoms, such as butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, icosanoic acid, or eicosenoic acid; and an unsaturated aliphatic monocarboxylic acid having 8 or more carbon atoms, such as oleic acid, elaidic acid, linoleic acid, or palmitoleic acid. In the case in which the resin composition contains a liquid medium, the resin composition may contain one type of liquid medium, or may contain two or more kinds of liquid media in combination.

When the resin composition contains a liquid medium, the content of the liquid medium in the resin composition is, for example, preferably from 1 to 10% by mass, more preferably from 4 to 10% by mass, and further preferably from 4 to 7% by mass, with respect to the total amount of the resin composition.

(Other Components)

The resin composition may further contain a component other than the components described above. For example, the resin composition may further contain a component such as a polymerization inhibitor, a silane coupling agent, a surfactant, an adhesion imparting agent, or an antioxidant. One type of such component may be used singly, or two or more types thereof may be used in combination.

(Method for Preparing Resin Composition)

The resin composition can be prepared by mixing a phosphor, a polymerizable compound, a photopolymerization initiator, and other components used as necessary, according to a common method.

The wavelength conversion layer may be a cured product of one type of resin composition, or may be a cured product of two or more types of resin compositions. For example, in a case in which the wavelength conversion member is in a form of a film, the wavelength conversion layer may be one in which a first cured product layer obtained by curing a resin composition containing a first phosphor and a second cured product layer obtained by curing a resin composition containing a second phosphor having a different emission property from that of the first phosphor are layered on one another.

The average thickness of the wavelength conversion layer is not particularly limited, and is, for example, preferably from 50 to 200 more preferably from 50 to 150 μm, and further preferably from 80 to 120 When the average thickness of the wavelength conversion layer is 50 μm or more, the wavelength conversion efficiency tends to be further improved, and when the average thickness of the wavelength conversion layer is 200 μm or less, a thinner backlight unit tends to be obtained when the wavelength conversion member is applied to a backlight unit described later. The average thickness of the wavelength conversion layer can be obtained as, for example, an arithmetic average value of the thicknesses of random three points measured using a micrometer.

The wavelength conversion layer can be obtained by forming a coating film, a molded product or the like of the resin composition, subjecting it to a drying process as necessary, and irradiating it with active energy rays such as UV rays. The wavelength and irradiation dose of the active energy rays can be determined as appropriate in accordance with the composition of the resin composition. In an embodiment, UV rays having a wavelength of 280 to 400 nm are irradiated at an irradiation dose of 100 to 5000 mJ/cm². The source of the UV rays may be a low pressure mercury lamp, a medium pressure mercury lamp, a high pressure mercury lamp, a super high pressure mercury lamp, a carbon arc lamp, a metal halide lamp, a xenon lamp, a chemical lamp, a black light lamp, or a microwave excited mercury lamp.

(Utilization of Wavelength Conversion Member)

The wavelength conversion member may be one that is to be provided to a backlight unit or an image display device, which will be described later. The wavelength conversion member according to the present disclosure is particularly suitable for a use in which the wavelength conversion member is disposed so as to oppose a light guide plate. Since the wavelength conversion member according to the present disclosure has excellent impact resistance, it is less prone to scratches even when disposed so as to oppose a face of a light guide plate having an arithmetic average roughness Ra of 30 μm or more, 40 μm or more, or 50 μm or more.

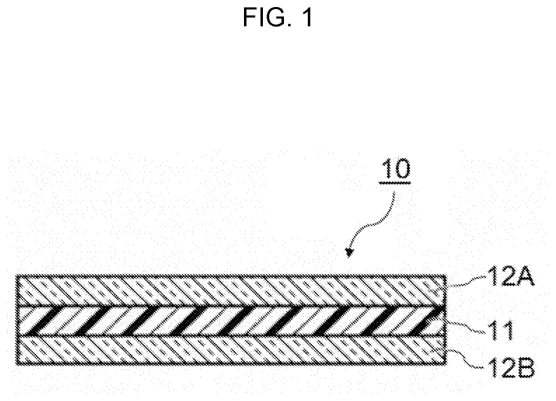

An example of a schematic configuration of the wavelength conversion member is illustrated in FIG. 1. However, the wavelength conversion member according to the present disclosure is not limited to the configuration of FIG. 1.

The wavelength conversion member 10 illustrated in FIG. 1 includes a wavelength conversion layer 11, which is a film-shaped cured product, and film-shaped covering materials 12A and 12B provided on respective sides of the wavelength conversion layer 11. The type and average thickness of the covering materials 12A and 12B may be the same as or different from each other.

In the wavelength conversion member 10, one or both of the faces at the sides of the covering materials 12A and 12B that are not adjacent to the wavelength conversion layer 11 satisfy the specific surface roughness (not illustrated), the covering materials 12A and 12B being disposed at respective sides of the wavelength conversion layer 11. In a case in which, for example, the covering material 12B is disposed so as to oppose a light guide plate, it is preferable that the face of the covering material 12B that is not adjacent to the wavelength conversion layer 11 satisfies the specific surface roughness.

The wavelength conversion member having the configuration illustrated in FIG. 1 can be manufactured by, for example, the following manufacturing method.

First, a resin composition for forming a wavelength conversion layer is applied to the surface of a film-shaped covering material (hereinafter also referred to as a “first covering material”), which is continuously conveyed, to form a coating film. The method for applying the resin composition is not particularly limited, and may be, for example, a die coating method, a curtain coating method, an extrusion coating method, a rod coating method, or a roll coating method.

Next, a film-shaped covering material (hereinafter also referred to as a “second covering material”), which is continuously conveyed, is pasted to the coating film of the resin composition.

Subsequently, the coating film is cured by irradiating the coating film with active energy rays from the side of one of the first covering material or the second covering material that is capable of transmitting the active energy rays, to form a cured product layer. Thereafter, by cutting the product into a prescribed size, a wavelength conversion member having the configuration illustrated in FIG. 1 can be obtained.

In a case in which neither the first covering material nor the second covering material is capable of transmitting the active energy rays, the cured product layer may be formed by irradiating the coating film with active energy rays before pasting the second covering material.

Backlight Unit

A backlight unit according to the present disclosure includes a light source and the wavelength conversion member according to the present disclosure.

From the viewpoint of improving color reproducibility, the backlight unit is preferably one provided with a multiwavelength light source. In a preferable embodiment, the backlight unit may be one that emits: blue light having a central emission wavelength within a wavelength range of from 430 to 480 nm and an emission intensity peak whose full width at half maximum is 100 nm or less; green light having a central emission wavelength within a wavelength range of from 520 to 560 nm and an emission intensity peak whose full width at half maximum is 100 nm or less; and red light having a central emission wavelength within a wavelength range of from 600 to 680 nm and an emission intensity peak whose full width at half maximum is 100 nm or less. The full width at half maximum of an emission intensity peak refers to the width of the peak at a height corresponding to a half of the height of the peak.

From the viewpoint of further improving the color reproducibility, the central emission wavelength of the blue light emitted from the backlight unit is preferably within a range of from 440 to 475 nm. From the same viewpoint, the central emission wavelength of the green light emitted from the backlight unit is preferably within a range of from 520 nm to 545 nm. Further, from the same viewpoint, the central emission wavelength of the red light emitted from the backlight unit is preferably within a range of from 610 to 640 nm.

Further, from the viewpoint of further improving the color reproducibility, the full width at half maximum of each of the emission intensity peaks of the blue light, green light, and red light emitted from the backlight unit is preferably 80 nm or less, more preferably 50 nm or less, further preferably 40 nm or less, particularly preferably 30 nm or less, and extremely preferably 25 nm or less.

As the light source of the backlight unit, for example, a light source that emits blue light having a central emission wavelength within a wavelength range of from 430 nm to 480 nm may be used. Examples of the light source include an LED (light emitting diode) and a laser. In the case of using a light source that emits blue light, it is preferable that the wavelength conversion member at least includes a quantum dot phosphor R, which emits red light, and a quantum dot phosphor G, which emits green light. As a result, white light can be achieved by the red light and green light emitted from the wavelength conversion member and blue light transmitted through the wavelength conversion member.

Further, as the light source of the backlight unit, for example, a light source that emits UV light having a central emission wavelength within a wavelength range of from 300 to 430 nm may be used. Examples of the light source include an LED and a laser. In the case of using a light source that emits UV light, it is preferable that the wavelength conversion member includes, in addition to the quantum dot phosphor R and the quantum dot phosphor G, a quantum dot phosphor B, which is excited by excitation light and emits blue light. As a result, white light can be achieved by the red light, the green light, and the blue light emitted from the wavelength conversion member.

The backlight unit according to the present disclosure may employ an edge-light system or a direct system.

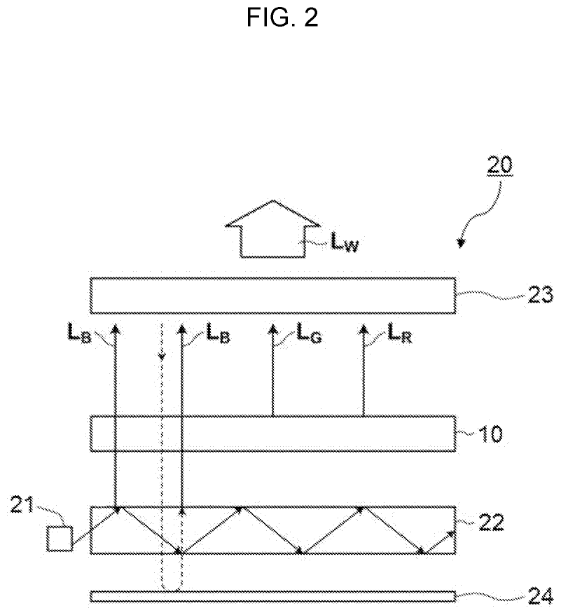

FIG. 2 illustrates an example of a schematic configuration of the backlight unit employing an edge-light system.

The backlight unit 20 illustrated in FIG. 2 includes: a light source 21, which emits blue light L_{B}; a light guide plate 22, which guides the blue light L_{B} emitted from the light source 21 and allows the blue light L_{B} to be emitted from the light guide plate 22; a wavelength conversion member 10 disposed so as to oppose the light guide plate 22; a retroreflective member 23 disposed so as to oppose the light guide plate 22 with the wavelength conversion member 10 interposed therebetween; and a reflector plate 24 disposed so as to oppose the wavelength conversion member 10 with the light guide plate 22 interposed therebetween. The wavelength conversion member 10 emits red light L_{R} and green light L_{G} using a part of the blue light L_{B} as exciting light, thereby outputting the red light L_{R} and the green light L_{G}, as well as blue light L_{B} that has not been used as the exciting light. The combination of the red light L_{R}, green light L_{G}, and blue light L_{B} results in white light L_{w} being emitted from the retroreflective member 23.

Image Display Device

An image display device according to the present disclosure includes the above-described backlight unit according to the present disclosure. The image display device is not particularly limited, and examples thereof include a liquid crystal display device such as a television, a personal computer, or a mobile phone.

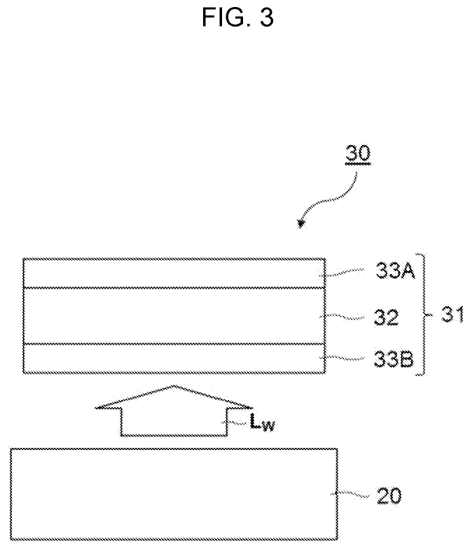

FIG. 3 illustrates an example of a schematic configuration of the liquid crystal display device.

The liquid crystal display device 30 illustrated in FIG. 3 includes a backlight unit 20 and a liquid crystal cell unit 31 disposed so as to oppose the backlight unit 20. The liquid crystal cell unit 31 has a configuration in which a liquid crystal cell 32 is disposed between a polarizing plate 33A and a polarizing plate 33B.

The driving mode of the liquid crystal cell 32 is not particularly limited, and examples thereof include TN (Twisted Nematic) mode, STN (Super Twisted Nematic) mode, VA (Vertical Alignment) mode, IPS (In-Plane-Switching) mode, and OCB (Optically Compensated Birefringence) mode.

Utilization of Wavelength Conversion Member

Utilization of a wavelength conversion member according to an embodiment of the present disclosure is utilization of the wavelength conversion member in an arrangement opposing a light guide plate having a face that has an arithmetic average roughness Ra of 30 μm or more, including disposing the wavelength conversion member such that the face of the wavelength conversion member having an arithmetic average roughness Ra of 5 μm or more and a maximum height Rz of from 30 to 250 μm opposes the face of the light guide plate having an arithmetic average roughness of Ra of 30 μm or more. The wavelength conversion member according to the present disclosure has excellent impact resistance, and therefore, is less prone to scratches even if it is disposed so as to oppose a face of a light guide plate having an arithmetic average roughness Ra of 30 μm or more, 40 μm or more, or 50 μm or more.

For example, in the backlight unit 20 illustrated in FIG. 2, the light guide plate 22 may have an arithmetic average roughness (not illustrated) of 30 μm or more, and the wavelength conversion member 10 may be disposed such that the face of the wavelength conversion member 10 having an arithmetic average roughness Ra of 5 μm or more and a maximum height of 30 to 250 μm opposes the face of the light guide plate having an arithmetic average roughness of 30 μm or more.

### EXAMPLES

Hereinafter, the disclosure will be described in detail below by way of Examples. However, the invention is not limited to these Examples.

### Example 1

[Production of Wavelength Conversion Member]

The following materials were mixed to prepare a resin composition.

Base resin 1: tricyclodecane dimethanol diacrylate (Sartomer, trade name: “SR833NS”), 68.1% by mass

Base resin 2: pentaerythritol tetrakis(3-mercaptopropionate) (Evans Chemetics LP, trade name: “PEMP”), 22.6% by mass

Light diffusion material: titanium oxide particles (Chemours Company, trade name: “Ti-Pure R-706”), 2.8% by mass

Photopolymerization initiator: 2,4,6-trimethylbenzoyl-diphenyl-phosphine oxide (IGM Resins, trade name: “SBPI-718”), 0.5% by mass

Additive: acetate (Kanto Chemical Co., Inc.), 0.5% by mass

Quantum dot phosphor 1: a quantom dot phsophor that emits green light, having a core of CdSe and a shell of ZnS (peak wavelength: 526 nm, full width at half maximum: 21 nm, dispersion medium: isobornyl acrylate, concentration of the quantum dot phosphor: 10% by mass, Nanosys Inc.), 3.2% by mass

Quantum dot phosphor 2: a quantom dot phsophor that emits red light, having a core of InP and a shell of ZnS (peak wavelength: 625 nm, full width at half maximum: 46 nm, dispersion medium: isobornyl acrylate, concentration of the quantum dot phosphor: 10% by mass, Nanosys Inc.), 2.3% by mass

The obtained resin composition was coated on the surface of a barrier film having a thickness of 72 μm, which is a covering material, on the side without a matte finish, to obtain a coating film. On the obtained coating film, a covering material of the same type as the foregoing was pasted. Subsequently, UV light was irradiated (irradiation dose: 1000 mJ/cm²) using a UV light irradiation apparatus (Eye Graphics Co., Ltd.) to cure the resin composition, thereby obtaining a wavelength conversion member having covering materials on respective sides of a wavelength conversion layer.

Each wavelength conversion member thus obtained was cut into a size of a width of 210 mm and a length of 300 mm to obtain a measurement sample. The sample thus obtained was subjected to the measurement of arithmetic average roughness Ra, arithmetic average height Sa, and maximum hight (Rz and Sz), as well as a vibration test, in accordance with the following methods. The results are shown in Table 2.

[Measurement of Arithmetic Average Roughness Ra and Arithmetic Average Height Sa]

The measurement was conducted using a 3D microscope (Olympus Corporation, model OLS4100, magnification: 10×).

The analysis range of the arithmetic average roughness (line roughness) was set to be a length of 1289 μm and the analysis range of the arithmetic average height (area roughness) Sa was set to be 1282 μm×1279 μm. As for the analysis method, analysis parameters were set to be roughness parameters with cutoff values of λC: none, λS: none, and λf: none.

[Measurement of Maximum Height Rz and Maximum Height Sz]

The measurement was conducted using a 3D microscope (Olympus Corporation, model OLS4100, magnification: 10×).

The analysis range of the maximum height Rz was set to be a length of 1289 μm and the analysis range of the maximum height Sa was set to be 1282 μm×1279 As for the analysis method, analysis parameters were set to be roughness parameters with cutoff values of λC: none, λS: none, and λf: none. Rz is calculated simultaneously with the calculation of Ra.

[Vibration Test]

A light guide plate (a light guide plate taken out from a television, NU8800U manufactured by Hisense; arithmetic average roughness Ra=79.5 μm, arithmetic average height Sa=81.6 μm; since the light guide plate had mountain-shaped stripes, Ra was measured vertically to the stripes) was fixed on a vibration tester (BF-50UD manufactured by Idex Co., Ltd.) such that the uneven surface of the light guide plate faced upward. A frame having a size of 20 mm longer in length and 20 mm wider in width than the A4 size was prepared using a plastic cardboard and was fixed on the light guide plate to obtain a test kit for the vibration test.

The wavelength conversion member was cut into an A4 size and was placed inside the frame made of a plastic cardboard. A SUS plate (A4 size, weight: 1.8 kg) was placed on the wavelength conversion member as a weight. Anticipating possible foreign objects, 10 glass beads having an average particle size of 0.2 mm were placed between the light guide plate and the wavelength conversion member. In the vibration test, four cycles were run under x-y two-axis vibrations, each cycle consisting of 10 minutes' sweep of from 10 to 60 Hz. After the vibration test was conducted, the appearance was visually observed, and the level (Lv) was identified based on the frequency of the generation of scratches, as shown in Table 1. Here, Lv0 and Lv1, which indicate that no scratches were observed or that only tiny scratches were observed, were regarded as acceptable, whereas Lv2 and Lv3, which indicate that clear scratches were observed, were regarded as unacceptable.

### Examples 2 to 6 and Comparative Examples 1 to 7

In each examples, the covering materials were replaced with covering materials having a different surface roughness, and the evaluation was conducted in the same manner as in Example 1. The results are shown in Tables 2 and 3.

TABLE 1

| Levels | Description (Frequency of Scraches) | Evaluation |
|---|---|---|
| Lv0 | No scratches | Acceptable |
| Lv1 | Tiny scraches | Acceptable |
| Lv2 | Few scrathces | Unacceptable |
| Lv3 | Many scrathces | Unacceptable |

TABLE 2

| Evaluation | | Example 1 | Example 2 | Example 3 | Example 4 | Example 5 | Example 6 |
|---|---|---|---|---|---|---|---|
| Ra | (μm) | 12.7 | 10.5 | 12.0 | 18.4 | 38.6 | 26.6 |
| Rz | (μm) | 76.7 | 63.6 | 75.0 | 118.6 | 146.5 | 96.8 |
| Sa | (μm) | 11.4 | 11.3 | 11.9 | 18.5 | 37.6 | 26.2 |
| Sz | (μm) | 93.5 | 88.3 | 90.4 | 118.9 | 177.1 | 121.6 |

| | | | | | | |
|---|---|---|---|---|---|---|
| Vibration test— | Lv0 | Lv0 | Lv0 | Lv0 | Lv0 | Lv0 |
| Scratch resistance | | | | | | |

TABLE 3

| | | Comparative | Comparative | Comparative | Comparative | Comparative | Comparative | Comparative |
|---|---|---|---|---|---|---|---|---|
| Evaluation | | Example 1 | Example 2 | Example 3 | Example 4 | Example 5 | Example 6 | Example 7 |
| Ra | (μm) | 0.2 | 0.4 | 1.0 | 1.2 | 1.3 | 1.4 | 1.4 |
| Rz | (μm) | 2.4 | 25.8 | 12.6 | 16.3 | 11.4 | 20.9 | 22.6 |
| Sa | (μm) | 0.2 | 0.4 | 1.0 | 1.2 | 1.3 | 1.4 | 1.4 |
| Sz | (μm) | 30.4 | 41.1 | 51.8 | 53.4 | 59.9 | 58.6 | 54.0 |

| | | | | | | | |
|---|---|---|---|---|---|---|---|
| Vibration test— | Lv3 | Lv3 | Lv3 | Lv3 | Lv3 | Lv3 | Lv3 |
| Scratch resistance | | | | | | | |

As shown in Tables 2 and 3, Examples 1 to 6, in which the wavelength conversion member had a face having an Rz of 5 μm or more and an Rz of from 30 to 250 μm, had a superior impact resistance as compared to Comparative Examples 1 to 7, in which this surface roughness were not satisfied.

All documents, patent applications, and technical standards described in the present disclosure are herein incorporated by reference to the same extent as if each individual document, patent application, or technical standard was specifically and individually indicated to be incorporated by reference.

### REFERENCE SIGNS LIST

10 Wavelength conversion member
11 Wavelength conversion layer
12A Covering material
12B Covering material
20 Backlight unit
21 Light source
22 Light guide plate
23 Retroreflective member
24 Reflector plate
30 Liquid crystal display device
31 Liquid crystal cell unit
32 Liquid crystal cell
33A Polarizing plate
33B Polarizing plate
L_{B} Blue light
L_{R} Red light
L_{G} Green light
L_{w} White light

1. A wavelength conversion member, comprising a wavelength conversion layer that comprises a phosphor, the wavelength conversion member having a face that has an arithmetic average roughness Ra of 5 μm or more and a maximum height Rz of from 30 to 250 μm.

2. The wavelength conversion member according to claim 1, comprising a covering material disposed at one side, or covering materials disposed at respective sides, of the wavelength conversion layer, wherein:
a face of the covering material disposed at one side of the wavelength conversion layer, the face being at a side that is not adjacent to the wavelength conversion layer, has an arithmetic average roughness Ra of 5 μm or more and a maximum height Rz of from 30 to 250 μm; or
at least one of the faces of the covering materials disposed at respective sides of the wavelength conversion member, the at least one of the faces being at a side that is not adjacent to the wavelength conversion layer, has an arithmetic average roughness Ra of 5 μm or more and a maximum height Rz of from 30 to 250 μm.

3. The wavelength conversion member according to claim 2, wherein the wavelength conversion member has a barrier property against at least one selected from the group consisting of oxygen and water.

4. The wavelength conversion member according to claim 1, wherein the phosphor comprises a quantum dot phosphor.

5. The wavelength conversion member according to claim 4, wherein the quantum dot phosphor comprises a compound that contains at least one selected from the group consisting of Cd and In.

6. The wavelength conversion member according to claim 1, wherein the wavelength conversion layer comprises a cured product of a resin composition that comprises:
a phosphor;
a thiol compound;
at least one selected from the group consisting of a (meth)acrylic compound and a (meth)allyl compound; and
a photopolymerization initiator.

7. A backlight unit, comprising the wavelength conversion member according to claim 1 and a light source.

8. The backlight unit according to claim 7, further comprising a light guide plate disposed so as to oppose the wavelength conversion member.

9. The backlight unit according to claim 8, wherein a face of the light guide plate that opposes the wavelength conversion member has an arithmetic average roughness Ra of 30 μm or more.

10. An image display device, comprising the backlight unit according to claim 7.

11. Utilizing the wavelength conversion member according to claim 1, in an arrangement opposing a light guide plate having a face that has an arithmetic average roughness Ra of 30 μm or more, comprising disposing the wavelength conversion member such that the face of the wavelength conversion member having an arithmetic average roughness Ra of 5 μm or more and a maximum height Rz of from 30 to 250 μm opposes the face of the light guide plate having an arithmetic average roughness Ra of 30 μm or more.
